(19) United States
(12) Patent Application Publication
(10) Pub. No.: US 2013/0283192 A1
(43) Pub. Date: Oct. 24, 2013

(54) Generation of Canvas Elements for Drawing Objects

(71) Applicants: Sean P. Kranzberg, Martinez, CA (US); Anthony C. Mowatt, Emeryville, CA (US); Eric J. Mueller, Los Gatos, CA (US)

(72) Inventors: Sean P. Kranzberg, Martinez, CA (US); Anthony C. Mowatt, Emeryville, CA (US); Eric J. Mueller, Los Gatos, CA (US)

(73) Assignee: Motorola Mobility, Inc., Libertyville, IL (US)

(21) Appl. No.: 13/451,027

(22) Filed: Apr. 19, 2012

(51) Int. Cl. G06F 3/048

(52) U.S. Cl. 715/760

(57) ABSTRACT

A method for creating a canvas element for a 3D object to be displayed in a browser includes: receiving a user input for a selection of a 3D object, which is to be displayed in the browser; receiving a user input for a location in the browser for displaying the 3D object; and receiving a user input for a size of the 3D object in the browser. The method further includes: receiving a user input for displaying the 3D object at the location and for the 3D object to have the size; creating a canvas element having location information for the location and size information for the size and in which the 3D object is to be displayed where the canvas element is created based on receiving the user input for displaying the 3D object; and displaying the 3D object in the canvas element in the browser.

### BACKGROUND

Particular embodiments generally relate to three-dimensional (3D) authoring tools.

Proprietary three-dimensional (3D) authoring tools allow a user to create 3D objects displayed on a display. The proprietary 3D authoring tools allow users to place 3D objects into a single 3D space, which is typically created when the proprietary 3D authoring tool is launched. Further, when the user uses a proprietary 3D authoring tool to create a 3D object, the 3D object can be placed into a 3D space with other 3D objects without the proprietary 3D authoring creating a new 3D space for the 3D object. Further, 3D objects may be copied from the 3D space and placed into the 3D space relatively simply because the coordinate system of the 3D space is continuous across the 3D space and because the proprietary 3D authoring tool actually transforms the position properties of the 3D object in the 3D space. Scalable vector graphics is a specification for a markup language file format for describing two-dimensional vector graphics that provide for the foregoing described creation of 3D objects in a web browser environment.

In contrast, in a canvas element based, 3D authoring tool (e.g., a hypertext markup language (HTML) 5 authoring tool) canvas elements need to be explicitly created as receptacles for 3D objects, which are to be created and then displayed in the canvas elements. That is, for a canvas element based, 3D authoring tool a single 3D space for creating and displaying 3D objects is not created by the canvas element based, 3D authoring tool when the canvas element based, 3D authoring tool is launched. The canvas elements are generally created dynamically. The dynamic creation of canvas elements provides programming challenges for canvas element based, 3D authoring tools.

### BRIEF DESCRIPTION OF THE DRAWINGS

FIG. 1 depicts an example of a computing device for displaying 3D objects according to one embodiment.

FIG. 2 depicts first and second canvas elements displayed in a browser according to one embodiment.

FIG. 3 depicts a simplified flowchart of a method for selecting a first 3D object from a first canvas element and copying the first 3D object to generate a second 3D object in a second canvas element.

FIG. 4 depicts a simplified flowchart of a method for creating a canvas element for a 3D object subsequent to a location being selected for the placement of the 3D object in a browser according to one embodiment.

FIG. 5 depicts a visual guide at several steps of the visual guide being expanded, for example, as the visual guide is made larger by moving a cursor across a display where the cursor represents one of the corners of the visual guide.

FIG. 6 depicts a 3D object (a circular cross-section of a generally round 3D object) displayed in the visual guide.

FIG. 7 depicts a simplified flowchart of a method for creating a canvas element, according to one embodiment, where the created canvas element is a union of at least two other canvas elements and where the created canvas element includes the 3D objects of the at least two other canvas elements.

FIG. 8 depicts a first canvas element, a second canvas element, and a third canvas element, which is the union of the first and the second canvas elements.

### DETAILED DESCRIPTION

Described herein are techniques for creating a canvas element for displaying a three dimensional (3D) object in the canvas element in a browser environment. In the following description, for purposes of explanation, numerous examples and specific details are set forth in order to provide a thorough understanding of embodiments of the present invention. Particular embodiments as defined by the claims may include some or all of the features in these examples alone or in combination with other features described below, and may further include modifications and equivalents of the features and concepts described herein.

In one embodiment, a method for creating a canvas element for a three dimensional (3D) object to be displayed in a browser includes receiving, via a computing device, a user input for a selection of a 3D object, which is to be displayed in the browser, and receiving, via the computing device, a user input for a location in the browser for displaying the 3D object. The method further includes receiving, via the computing device, a user input for a size of the 3D object in the browser, and receiving, via the computing device, a user input for displaying the 3D object at the location and for the 3D object to have the size. The method further includes creating, via the computing device, a canvas element having location information for the location and size information for the size and in which the 3D object is to be displayed. The canvas element is created based on receiving the user input for displaying the 3D object. The method further includes displaying, via the computing device, the 3D object in the canvas element in the browser.

According to another embodiment, a non-transitory computer-readable storage medium comprises instructions for creating a canvas element for a three dimensional (3D) object to be displayed in a browser. The instructions are configured for controlling a computer system to be operable for: receiving a user input for a selection of a 3D object, which is to be displayed in the browser; receiving a user input for a location in the browser for displaying the 3D object; and receiving a user input for a size of the 3D object in the browser. The instructions are further configured for controlling the computer system to be operable for: receiving a user input for displaying the 3D object at the location and for the 3D object to have the size; and creating a canvas element having location information for the location and size information for the size and in which the 3D object is to be displayed. The canvas element is created based on receiving the user input for displaying the 3D object. The instructions are further configured for controlling the computer system to be operable for displaying the 3D object in the canvas element in the browser.

An apparatus configured to create a canvas element for a three dimensional (3D) object to be displayed in a browser includes: one or more computer processors; and a computer-readable storage medium includes instructions for controlling the one or more computer processors to be operable for: receiving a user input for a selection of a 3D object, which is to be displayed in the browser, and receiving a user input for a location in the browser for displaying the 3D object. The computer-readable storage medium further includes instructions for controlling the one or more computer processors to be operable for: receiving a user input for a size of the 3D object in the browser, and receiving a user input for displaying the 3D object at the location and for the 3D object to have the size. The computer-readable storage medium further includes instructions for controlling the one or more computer processors to be operable for creating a canvas element having location information for the location and size information for the size and in which the 3D object is to be displayed. The canvas element is created based on receiving the user input for displaying the 3D object. The computer-readable storage medium further includes instructions for controlling the one or more computer processors to be operable for displaying the 3D object in the canvas element in the browser. The following portions of the detailed description and the accompanying drawings provide a more detailed understanding of the nature and advantages of the described embodiments.

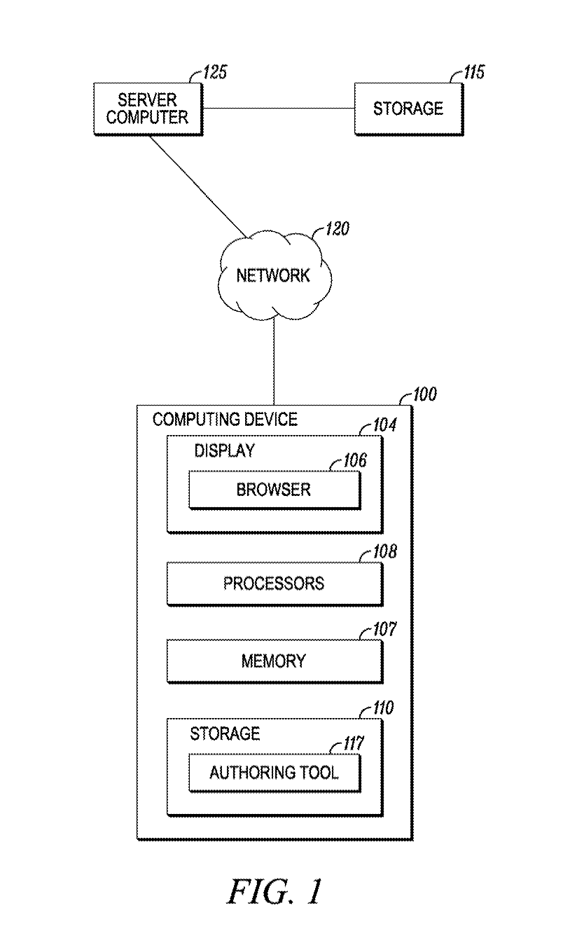

FIG. 1 depicts an example of a computing device 100 for displaying 3D objects, and for copying and pasting the displayed 3D objects according to one embodiment. Computing device 100 includes a display 104 in which a browser 106 is used to display 3D objects in canvas elements. Browser 106 may be a software application that is used to display pages, such as web pages, based on a software code, such as hypertext transfer markup language (HTML) 5 or other languages that can be used to display pages in browser 106. In one embodiment, HTML5 is a universal software programming language that can be used across different computing platforms and environments.

Computing device 100 may be any of a variety of devices capable of operating a browser for displaying 3D objects. For example, computing device (or a computer) 100 may be a personal computer (PC), a laptop computer, a tablet computer, a server computer running a server operating system, a personal digital assistant capable of operating a browser, a smart phone capable of operating a browser, a game machine capable of operating a browser, etc.

Computing device 100 may include a local memory 107 and a set of processors 108 for executing software code for software applications where the software code may be stored in local memory 107 and transferred to set of processors 108 for processing. A set as referred to herein includes one or more elements. Computing device 100 may include a storage device 110 for storing computer information, or may receive computer information from a remote storage device 115, which may be coupled to computing device 100 via a network 120. A server computer 125 may provide computer information from remote storage device 115 to computing device 100. Computer information stored on storage devices 110 and 115 may include software code for software applications and may include various computerized data used by the software applications. Storage devices 110 and 115 may be non-transitory storage devices and one or both of these storage devices may store software code, which embodies various embodiments of the present invention. Local memory 107 may be a semiconductor memory or the like and may receive computer information from storage devices 110 and/or 115.

Software code stored in storage devices 110 and/or 115 may be for a software application, such as an authoring tool 117. Authoring tool 117 operating on set of processors 108 may display 3D objects in canvas elements in browser 106 according to one embodiment. Authorizing tool 117 may allow users to “draw” 3D objects for display of the 3D objects in canvas elements in browser 106. According to one embodiment, authoring tool 117 may also generate a markup language document, which includes instructions for the canvas elements and the 3D objects. The instructions may be markup language instructions, scripts, etc. The markup language document may be stored in one or both of storage devices 110 and 115 and may be retrieved therefrom by a user via the operation of a user computer for subsequent use, such inclusion of the instructions in other markup language documents for display of the generated 3D objects in web pages or the like.

Copying a Drawing Object from a Canvas Element

According to one embodiment, authorizing tool 117 copies a 3D object displayed in a first canvas element and thereafter displays the 3D object in a second canvas element. Selection and copying of 3D objects is described in further detail immediately below.

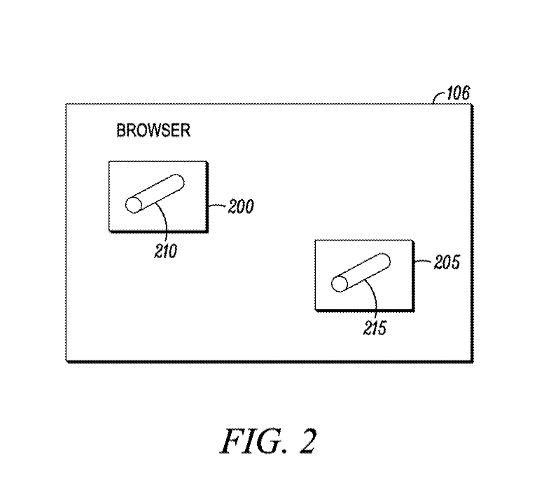

FIG. 2 depicts first and second canvas elements 200 and 205 displayed in a browser 106 according to one embodiment. First and second canvas elements 200 and 205 are independent canvas elements. For clarification, each canvas element is shown in FIG. 2 with a surrounding bounding line. First canvas element 200 includes a first 3D object 210. While first canvas element 200 is shown as including one 3D object (i.e., first 3D object 210), the first canvas element may include a number of 3D objects. Second canvas element 205 is shown as including a second 3D object 215 where second 3D object 215 is a copy of first 3D object 210. Second 3D object 215 may be a copied from a set of 3D objects, which is displayed in first canvas element 200 and includes first 3D object 210. A method of copying first 3D object 210 to create second 3D object 215 is described immediately below.

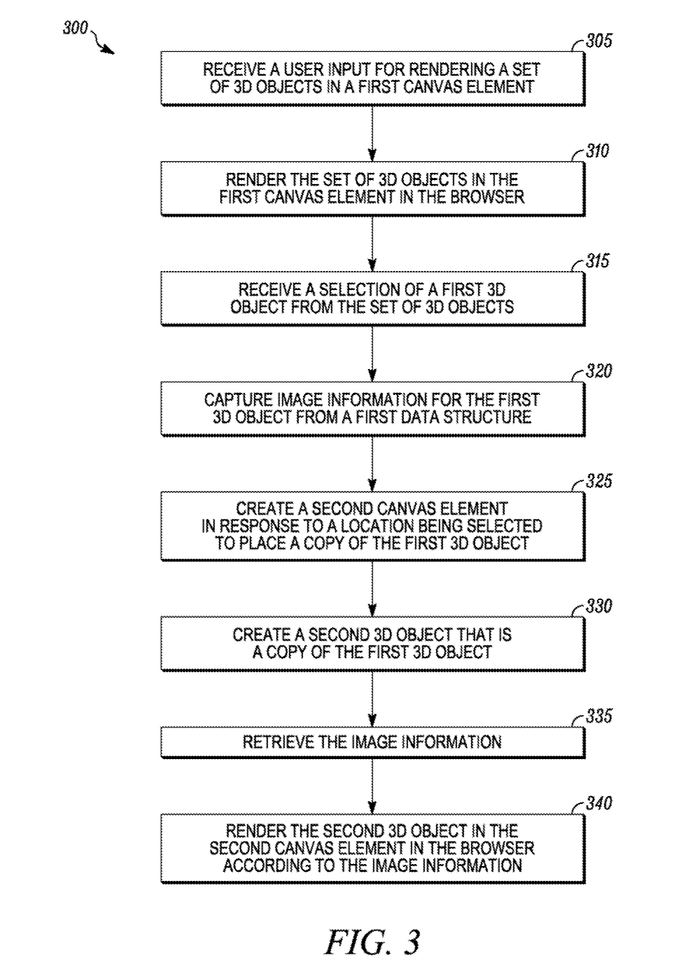

FIG. 3 depicts a simplified flowchart 300 of a method for selecting first 3D object 210 from the first canvas element 200 and copying the first 3D object to create second 3D object 215 and display second 3D object 215 in second canvas element 205. The simplified flowchart represents an example embodiment and those of skill in the art will understand that various steps shown in the simplified flow chart may be added and/or combined without deviating from the purview of the described embodiment.

At 305, authoring tool 117 receives a user input for displaying a set of 3D objects, which includes first 3D object 210, in first canvas element 200 in browser 106 on display 104. The user input for displaying the set of 3D objects may be received by authoring tool 117 from one or more of a variety of devices, such a mouse, a touch pad, a touch screen, a keyboard, or the like. According to one embodiment, the set of 3D objects and first canvas element 200 may be created in a document in local memory 107 and the document may be stored in one or both of storage devices 110 and 115. The document may be a markup language document with markup language instructions, scripts, etc. for first canvas element 200 and/or the set of 3D objects. The document may be created in local memory 107 as the steps of the method are executed by authoring tool 117, and thereafter the document may be stored in one or both of storage devices 110 and 115 after the method is finished. The document may be stored in one or both of storage devices 110 and 115 in response to authoring tool 117 receiving a user input from a user for storing the document. While the method described herein provides for displaying and copying a 3D object, the method may be similarly applied to a 2D object. For convenience, 3D objects and 2D objects are sometimes referred to herein as drawing objects.

At 310, in response to receiving the user input at 305, authoring tool 117 displays the set of 3D objects in first canvas element 200 in browser 106. The set of 3D objects may be displayed in first canvas element 200 via a set of scripts specified and executed by authoring tool 117. According to one embodiment, the set of scripts may access a data structure that includes image information for image properties of the set of 3D objects, and the set of 3D objects may be displayed according to the image information. The image information may include one or more of: i) geometry information for the set of 3D objects, ii) lighting information for the set of 3D objects, iii) material information for the set of 3D objects, and iv) camera orientation information for the set of 3D objects. The geometry information may include information for basic shapes (e.g., triangles, rectangles, etc.) for building the set of 3D objects. The lighting information may include information for lighting direction, lighting color, etc. for the set of 3D objects. The material information may include information for surface properties for the set of 3D objects. The camera orientation information may include information for a camera angle of a camera view of the set of 3D objects with respect to displaying the set of 3D objects on the display. The data structure may be stored locally in local memory 107 of computing device 100 or in one or both of storage devices 110 and 115. The data structure for the image information may provide a hierarchical structure for the image information.

At 315, a selection of first 3D object 210 from the set of 3D objects is received by authoring tool 117. The selection may be received from a user input to the computer via one or more of a variety of devices, such as one of the devices described above at 305. For example, a cursor may be placed over first 3D object 210 in first canvas element 200 via user control of a mouse and the first 3D object may be selected via a button press or the like on the mouse. Authoring tool 117 may capture the user input.

At 320, authoring tool 117 captures image information of first 3D object 210 in response to receiving the selection of the first 3D object at 315. The image information for first 3D object 315 may be captured from the data structure for the set of 3D objects described above at 310. The captured image information may include one or more of: i) the geometry information for first 3D object 210, ii) the lighting information for the first 3D object, iii) the material information for the first 3D object, and iv) the camera orientation information for the first 3D object. The image information captured by computing device 100 may be stored in a second data structure, which stores a hierarchical structure of the image information. The captured image information stored in the second data structure may be a sub-set of the image information of first 3D object 210 stored in the first data structure. That is, the captured image information stored in the second data structure may be a condensed form of the image information of first 3D object 210 stored in the first data structure.

At 325, authoring tool 117 creates second canvas element 205. Second canvas element 205 is independent of first canvas element 200. The dimensions (e.g., height and width) of second canvas element 205 may be the same as the dimensions of first canvas element 200. Second canvas element 205 may be created in response to first 3D object 210 being selected for copying. Alternatively, second canvas element 205 may be created in response to a location being selected (e.g., by a user via use of a mouse or the like) at which second 3D object 215 is to be displayed in second canvas element 205 in browser 106. Second canvas element 205 may be created with location information for the location. For example, the location at which second 3D object 215 is to be displayed in second canvas element 205 in browser 106 may be selected via the placement of a cursor or the like at a location in browser 106, and authoring tool 117 may receive a selection for the location. Authoring tool 117 may receive a selection for the location from the press of a mouse button, the release of a mouse button, a keyboard input, or the like. As briefly described above, first 3D object 210 may be selected at 315 via the placement of a cursor over the first 3D object in browser 106, and an input (e.g., a button press of a mouse or the like) may be received to complete the selection. The cursor may be them be moved (e.g., “dragged” by movement of a mouse or the like) to a location at which second 3D object 215 is to be displayed. A second input (e.g., release of the pressed mouse button or the like) may be received to identify the location at which second 3D object 215 is to be displayed. Second canvas element 205 may be created in response to receipt of the second input. Those of skill in the art will understand that other devices (touch pads, keyboards, touch screens, etc.) may generate the inputs and selections described above. Authoring tool 117 may specify markup language instructions, a set of scripts, etc. in the document for the creation second canvas element 205. Authoring tool 117 may also capture the above described input.

At 330, authoring tool 117 specifies instructions for creating second 3D object 215 where the second 3D object is a copy of first 3D object 210. According to one embodiment, authoring tool 117 may specify markup language instructions, scripts, etc. for the creation of second 3D object 215 in second canvas element 205. According to a further embodiment, the instructions specified by authoring tool 117 for second canvas element 205 and/or second 3D object 215 are for generating a document object model (DOM) level element for second canvas element 205 and/or second 3D object 215. According to another embodiment, the markup language instructions and/or the scripts specified for second 3D object 215 may be the same (e.g., copies of) markup language instructions and/or scripts for first 3D object 210.

At 335, authoring tool 117 retrieves the image information from the second data structure in which the image information for second 3D object 215 is stored so that the second 3D object may be displayed in second canvas element 205 in browser 106 according to the image information.

At 340, authoring tool 117 displays second 3D object 215 in second canvas element 205 in browser 106 according to the image information. Set of processors 108 may specify and execute instructions for creating and displaying second 3D object 215 in second canvas element 205. The specified instructions for second 3D object 215 use the image information in the second data structure to display the second 3D object with geometry, lighting, material information, and camera orientation that matches first 3D object 210. As described briefly above, second 3D object 215 may be displayed in response to a user input (such as the first input and/or the second input described at 325) from an input device. Second 3D object 215 may be displayed at the identified location described at 325. The user input might be a button press of a mouse, a release of a pressed button of a mouse, or the like for the placement of a cursor at the location in browser 106. For example, a user operating a mouse or the like may move a cursor to the location in browser 106 at which second 3D object 215 is to be displayed and the user may press, or release, a button on a mouse to indicate that the second 3D object is to be displayed at the location of the cursor.

### Generation of HTML Canvas Elements for Drawing Objects

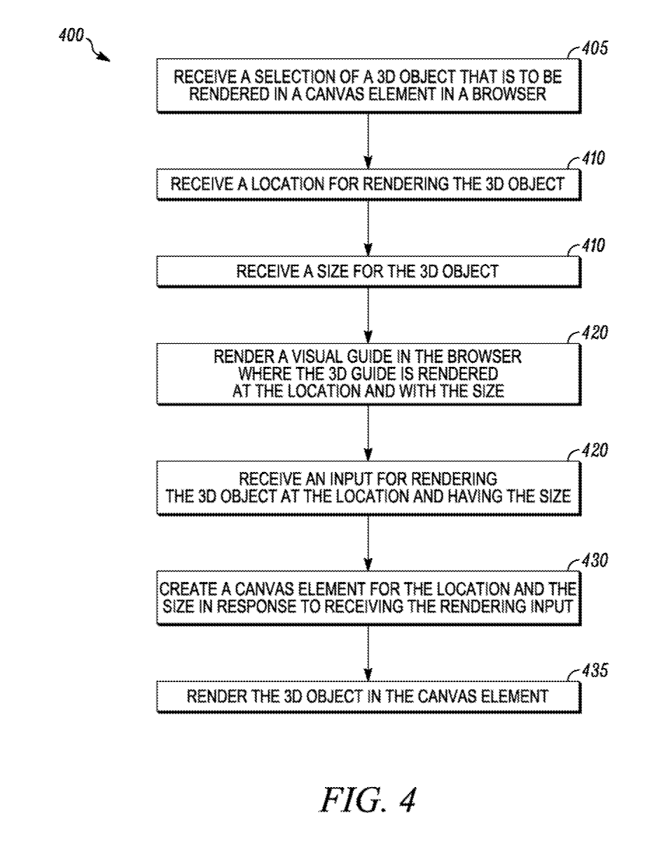

FIG. 4 depicts a simplified flowchart 400 of a method for creating a canvas element for a 3D object subsequent to a location being selected for the placement of the 3D object in a browser and subsequent to a size of the 3D object being selected. The simplified flowchart represents an example embodiment and those of skill in the art will understand that various steps shown in the simplified flow chart may be added and/or combined without deviating from the purview of the described embodiment.

At 405, authoring tool 117 receives a user input for a selection of a 3D object, which is to be displayed in a canvas element in browser 106. The user input may be received via a user interface of authoring tool 117 where the user interface is displayed in browser 106. The user interface may provide a number of menus from which various 3D objects may be selected. The user input may be may be generated by a mouse or the like.

At 410, authoring tool 117 receives a user input for a location for displaying the 3D object in browser 106. The location for the 3D object may be received by set of processors 108 via a variety of methods, such as the receipt of a set of coordinates (coordinates in browser 106) entered via a keyboard or the like. Alternatively, the location for the 3D object may be received by set of processors 108 by tracking a set of coordinates of a cursor moved in browser 106 where the cursor may be moved by a mouse or the like and the location may be indicated via a button press of the mouse or the like. A set of scripts of authoring tool 117 may capture the location.

At 415, authoring tool 117 receives a user input for a size of the 3D object for display in browser 106. The size for the 3D object may be received by authoring tool 117 via a variety of methods, such as the receipt of sets of coordinates entered via a keyboard or the like. Alternatively, the size of the 3D object may be received by tracking the coordinates of a cursor (controlled by a mouse or the like) where the cursor is moved in browser 106 from a first location (e.g., the location received at 410) having a first set of coordinates to a second location having a second set of coordinates. The first and the second sets of coordinates may define the size of the 3D object, for example, by defining the coordinates of an area (e.g., a rectangular area or the like) into which the 3D object is to be displayed. A set of scripts of authoring tool 117 may capture the size information for the 3D object.

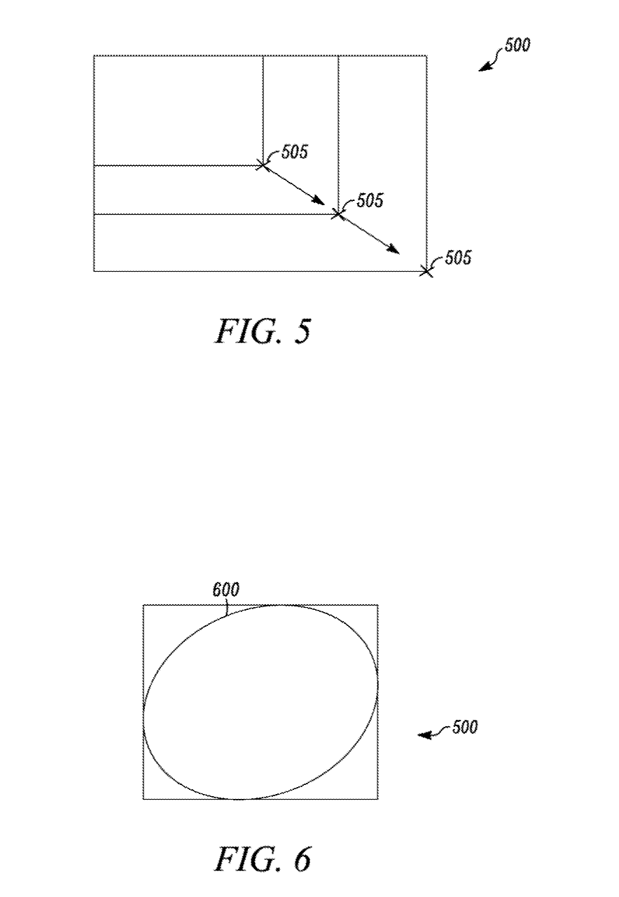

At 420, authoring tool 117 may display a visual guide in browser 106 where the visual guide provides a visual indication of the location and the size of the 3D object in browser 106. FIG. 5 depicts a visual guide 500 at several steps of the visual guide being expanded, for example, as the visual guide is made larger by moving a cursor 505 across display 104 where the cursor represents one of the corners of the visual guide. The arrows in FIG. 5 indicate an example movement direction of cursor 505. The visual guide has the location and size specified at 410 and 415. The visual guide may be a rectangle (as shown in FIG. 5) or other useful shape. Set of processors 108 may alter a size of the visual guide (as shown in FIG. 5) in browser 106 if the set of processors received altering size information for the 3D object (i.e., repeating step 415).

At 425, authoring tool 117 receives a user input for displaying the 3D object at the location and according to the size. The user input may be received by a variety of methods, such as a button press of a mouse, a keyboard, a touch pad, etc. A set of scripts of authoring tool 117 operating on set of processors 108 may capture the user input at 425.

At 430, authoring tool 117 creates a canvas element in which the 3D object is to be displayed. The canvas element is created in response to the receipt of user input for displaying the 3D object. The canvas element may be created by a set of scripts of authoring tool 117 operating on set of processors 108. The set of scripts may create instructions for the canvas element in a document in local memory 107 of computing device 100. The document may be a markup language document. The set of scripts may create the canvas element at the location received at 415 and with the size received at 420. The canvas element is a DOM level element.

At 435, authoring tool 117 displays the 3D object in the canvas element in browser 106. FIG. 6 depicts a 3D object 600 (a circular cross-section of a generally round 3D object) displayed in visual guide 500. Subsequent to the 3D object being displayed, the visual guide for the 3D object may be removed from browser 106. Alternatively, the visual guide may be removed from browser 106 before the 3D object is displayed in browser 106.

According to one embodiment, authoring tool 117 may specify a set of scripts for displaying the 3D object in the canvas element. Further, the set of scripts of authoring tool 117 may create instructions (markup language instructions, a set of scripts, etc.) for the 3D object in the document in which the instructions for the canvas element are created. The set of scripts of authoring tool 117 may also create image information for the 3D object and store the image information in a data structure where the image information includes a set of lighting information, geometry information, material information, camera orientation information, or other useful information for a 3D object. The image information may be created from various user inputs received by authoring tool 117. For example, the image information may be received from user selectable options provided by a user interface of authoring tool 117. The set of scripts may control display of the 3D object, may retrieve the image information for the 3D object, and may operate on the image information to display the 3D object according to the image information (e.g., lighting information, geometry information, material information, camera orientation information, etc.) in the data structure. Authoring tool 117 may save the document and the data structure to a non-transitory memory where the document and the data structure may be retrieved and interpreted by a browser for displaying the 3D object. The saved document may be accessible to web developers or the like for incorporating the 3D object into web pages via a markup language document.

Merging Drawing Objects from One or More Canvas Elements

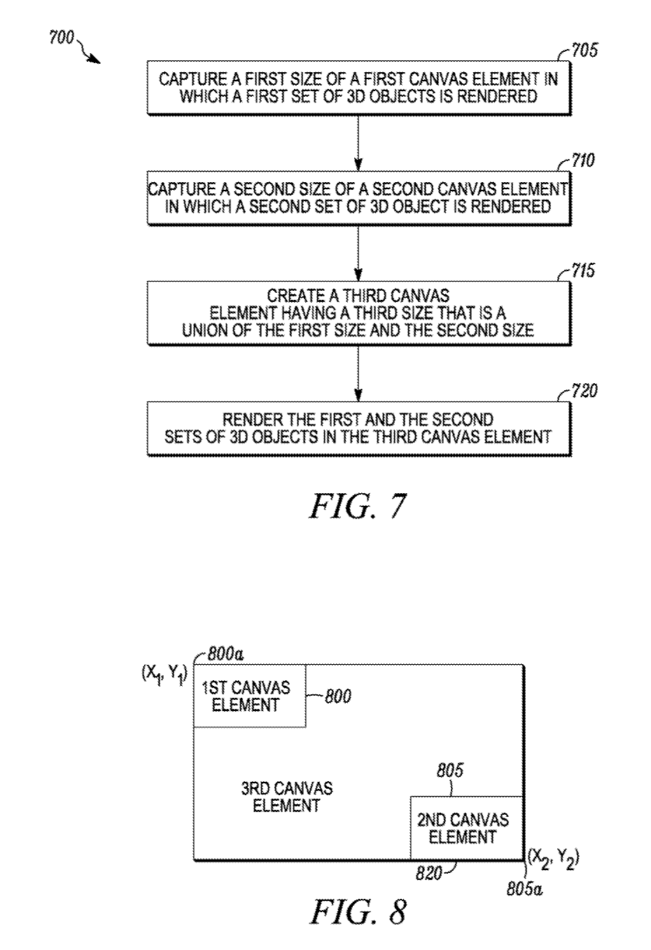

FIG. 7 depicts a simplified flowchart 700 of a method for creating a canvas element, according to one embodiment, where the created canvas element is a union of at least two other canvas elements and where the created canvas element includes the 3D objects of the at least two other canvas elements. The simplified flowchart represents an example embodiment and those of skill in the art will understand that various steps shown in the simplified flow chart may be added and/or combined without deviating from the purview of the described embodiment. FIG. 8 depicts a first canvas element 800, a second canvas element 805, and a third canvas element 820, which has a size that is the union of the first canvas element and the second canvas element.

At 705, authoring tool 117 captures a first size of first canvas element 800 in which a first set of 3D objects is displayed in browser 106. The first size of first canvas element 800 may be captured from computer memory by authoring tool 117. Authoring tool 117 may create first canvas element 800 in the computer memory. According to one embodiment, authoring tool 117 generates a document in computer memory where the document includes instructions in a markup language, scripts, etc. for first canvas element 800 and the first set of 3D objects. The computer memory may be local memory 107 or may be one or both of storage devices 110 and 115. It will be understood by those of skill in the art that the document in local memory 107 may have a different form from the document stored in storage devices 110 and 115.

At 710, authoring tool 117 captures a second size of second canvas element 805 in which a second set of 3D objects is displayed in browser 106. The second size of second canvas element 805 may be captured from computer memory by authoring tool 117. Authoring tool 117 may create second canvas element 805 in the computer memory. According to one embodiment, authoring tool 117 generates instructions in a markup language, scripts, etc. in the document for second canvas element 805 and the second set of 3D objects.

The first and the second sizes of first and second canvas elements 800 and 805 may be captured subsequent to set of processors 108 receiving user selections of the first and the second canvas elements. First and the second canvas elements 800 and 805 may be selected by a variety of methods, such as via a keyboard selection, a cursor selection under mouse control, touchpad control, etc.

At 715, authoring tool 117 creates third canvas element 820 having a third size that is a union the first size of first canvas element 800 and the second size of second canvas element 805.

According to one specific embodiment, coordinates for third canvas element 820 match selected coordinates of the first size of first canvas element 800 and the second size of second canvas element 805 where the selected coordinates include the coordinates having the greatest (i.e., largest and smallest) vertical (e.g., x-axis) extent and the greatest horizontal (e.g., y-axis) extent of first and the second canvas elements 800 and 805. For example, a first corner 800a of first canvas element 800, shown in FIG. 8, has the smallest y coordinate (e.g., y1) and the largest x-coordinate (e.g., x1) where the smallest y-coordinate has the smallest horizontal extent and the largest x-coordinate has the largest vertical extent. Further, a first corner 805a of the second canvas element 805 has the largest y coordinate (e.g., y2) and the smallest x-coordinate (e.g., x2) where the largest y-coordinate has the largest horizontal extent and the smallest x-coordinate has the smallest vertical extent. That is, the four coordinates x1, x2, y1, and y2 having the greatest vertical extent and the greatest horizontal extent are the union of first canvas element 800 and second canvas element 805. Therefore, third canvas element 820 may have a size that is defined by these smallest and largest x and y coordinates. For example, third canvas element 820 may have x coordinates of x1 and x2 and may have y coordinates of y1 and y2 where x1 and x2 are the greatest vertical extent of first and second canvas elements 800 and 805, and y1 and y2 are the greatest horizontal extent of first and second canvas elements 800 and 805.

At 715, authoring tool 117 displays the first and the second sets of 3D objects in third canvas element 820 in browser 106. Set of processors 108 may display the first and the second sets of 3D objects in third canvas element 820 in browser 106 after receiving a user input for such display. Subsequent to receiving the user input for displaying the first and the second sets of 3D objects in third canvas element 820, set of processors 108 may stop displaying the first and the second sets of 3D objects in first and second canvas elements 800 and 805. That is, set of processors 108 may stop displaying the first and the second sets of 3D objects in first and second canvas element 800 and 805 on display 104.

According to one embodiment, authoring tool 117 captures sets of location coordinates at which the 3D objects in the first and the second set of 3D objects are displayed in browser 106. The 3D objects in the first and the second set of 3D objects may be displayed in third canvas element 820 at the sets of location coordinates. That is, the 3D objects in the first and the second sets of 3D objects may be displayed in third canvas element 820 at the sets of location coordinates and may appear at the same locations on display 104 as compared to the 3D object having been displayed in first and second canvas elements 800 and 805.

According to one embodiment, authoring tool 117 generates a document, such as an HTML document, having instructions for creating third canvas element 820. More specifically, authoring tool 117 may specify markup language instructions, a set of scripts, etc. for the creation and displaying of third canvas element 820. The document may be saved in local memory 107 and may thereafter be stored in one or both of storage devices 110 and 115 where the document may be used by a user to generate markup language documents for use by a browser or the like for displaying web pages that include the 3D objects displayed in third canvas element 820 in browser 106. Authoring tool 117 may further specify instructions in the document for the first and the second sets 3D objects so that these 3D objects may be displayed in third canvas element 820 in browser 106.

According to a further embodiment, authoring tool 117 captures a first set of image information for the first set of 3D objects, and capture a second set of image information for the second set of 3D objects. The image information may be captured from first and second data structures that respectively store the image information for the first set of 3D objects and the second set of 3D objects. The first and the second data structures may be stored in local memory 107, in one or both of storage devices 110 and 115, or the like.

Authoring tool 117 may generate a third set of image information that is a combination of the first and the second sets of image information. The third set of image information may be stored in a third data structure which stores the image information in a hierarchy of image information for the first and the second sets of 3D objects.

At 715, described above, displaying the first and the second sets of 3D objects in third canvas element 820 in browser 106 may include displaying the first and the second sets of 3D objects according to the third set of image information in the third data structure. That is, the first and the second sets of 3D objects may be displayed according to: i) the geometry information for the first and the second sets of 3D objects in the third data structure, ii) the lighting information for the first and the second sets of 3D objects in the third data structure, iii) the material information for the first and the second sets of 3D objects in the third data structure, and iv) the camera orientation information for the first and the second sets of 3D objects in the third data structure.

Particular embodiments may be implemented in a non-transitory computer-readable storage medium for use by or in connection with the instruction execution system, apparatus, system, or machine. The computer-readable storage medium contains instructions for controlling a computer system to perform a method described by particular embodiments. The instructions, when executed by one or more computer processors, may be operable to perform that which is described in particular embodiments.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations, and equivalents may be employed without departing from the scope of the invention as defined by the claims.

What is claimed is:

1. A method operable on a computing device for creating a canvas element for a three dimensional (3D) object to be displayed in a browser, the method comprising:
receiving, via the computing device, a user input for a selection of a 3D object, which is to be displayed in the browser;
receiving, via the computing device, a user input for a location in the browser for displaying the 3D object;
receiving, via the computing device, a user input for a size of the 3D object in the browser;
receiving, via the computing device, a user input for displaying the 3D object at the location and for the 3D object to have the size;
creating, via the computing device, a canvas element having location information for the location and size information for the size and in which the 3D object is to be displayed, wherein the canvas element is created based on receiving the user input for displaying the 3D object; and
displaying, via the computing device, the 3D object in the canvas element in the browser.

2. The method of claim 1, further comprising:
displaying the 3D object at the location; and
displaying the 3D object to have the size.

3. The method of claim 2, wherein receiving the location information for the location includes receiving the location information as the visual guide is expanded by the user, via the computing device, in the browser.

4. The method of claim 3, wherein receiving the size information for the size includes receiving the size information as the visual guide is expanded by the user, via the computing device, in the browser.

5. The method of claim 2, wherein receiving, via the computing device, the user input for the location includes:
tracking, via the computing device, a set of coordinates of a cursor moved in the browser,
receiving, via the computing device, a selection of a set of final coordinates at which the cursor is placed, and
capturing, via the computing device, the set of final coordinates and using the set of final coordinate to specify the location.

6. The method of claim 5, wherein
the set of coordinates comprises a first set of coordinates, and
receiving, via the computing device, the user input for the size of the 3D object in the browser includes tracking movement of the cursor in the browser from the location having the first set of coordinates to a second location having a second set of coordinates, wherein the first and the second sets of coordinates define the size of the 3D object.

7. The method of claim 2, further comprising displaying, via the computing device, a visual guide in the browser, wherein the visual guide is a visual indication of the location and the size of the 3D object in the browser.

8. The method of claim 7, further comprising removing, via the computing device, the visual guide from the browser based on displaying the 3D object in the canvas element in the browser.

9. The method of claim 1, wherein creating a canvas element includes creating, via the computing device, a document that includes instructions for the canvas element, and instructions for displaying the 3D object in the canvas element in the browser; wherein the instruction are configured to be interpreted by the browser for displaying the 3D object in the canvas element in the browser.

10. The method of claim 9, wherein the document is a markup language document.

11. A non-transitory computer-readable storage medium comprises instructions for creating a canvas element for a three dimensional (3D) object to be displayed in a browser, the instructions for controlling a computer system to be operable for:
receiving a user input for a selection of a 3D object, which is to be displayed in the browser;
receiving a user input for a location in the browser for displaying the 3D object;
receiving a user input for a size of the 3D object in the browser;
receiving a user input for displaying the 3D object at the location and for the 3D object to have the size;
creating a canvas element having location information for the location and size information for the size and in which the 3D object is to be displayed, wherein the canvas element is created based on receiving the user input for displaying the 3D object; and
displaying the 3D object in the canvas element in the browser.

12. The non-transitory computer-readable storage medium of claim 11, wherein the instruction are further configured for controlling the computer system to be operable for:
displaying the 3D object at the location; and
displaying the 3D object to have the size.

13. The non-transitory computer-readable storage medium of claim 12, wherein receiving the location information for the location includes receiving the location information as the visual guide is expanded by the user, via the computing device, in the browser.

14. The non-transitory computer-readable storage medium of claim 13, wherein receiving the size information for the size includes receiving the size information as the visual guide is expanded by the user, via the computing device, in the browser.

15. The non-transitory computer-readable storage medium of claim 12, wherein receiving the user input for the location includes:
tracking a set of coordinates of a cursor moved in the browser,
receiving a selection of a set of final coordinates at which the cursor is placed, and
capturing the set of final coordinates and using the set of final coordinate to specify the location.

16. The non-transitory computer-readable storage medium of claim 15, wherein:
the set of coordinates comprises a first set of coordinates, and
receiving the user input for the size of the 3D object in the browser includes tracking movement of the cursor in the browser from the location having the first set of coordinates to a second location having a second set of coordinates, wherein the first and the second sets of coordinates define the size of the 3D object.

17. The non-transitory computer-readable storage medium of claim 12, wherein the instruction are further configured for controlling the computer system to be operable for:
displaying a visual guide in the browser, wherein the visual guide is a visual indication of the location and the size of the 3D object in the browser, and
removing the visual guide from the browser based on displaying the 3D object in the canvas element in the browser.

18. An apparatus configured to create a canvas element for a three dimensional (3D) object to be displayed in a browser, the apparatus comprising:
one or more computer processors; and
a computer-readable storage medium comprising instructions for controlling the one or more computer processors to be operable for:
receiving a user input for a selection of a 3D object, which is to be displayed in the browser;
receiving a user input for a location in the browser for displaying the 3D object;
receiving a user input for a size of the 3D object in the browser;
receiving a user input for displaying the 3D object at the location and for the 3D object to have the size;
creating a canvas element having location information for the location and size information for the size and in which the 3D object is to be displayed, wherein the canvas element is created based on receiving the user input for displaying the 3D object; and
displaying the 3D object in the canvas element in the browser.

19. The apparatus of claim 18, wherein the instructions are further configured for controlling the one or more computer processors to be operable for:
displaying the 3D object at the location; and
displaying the 3D object to have the size.

20. The apparatus of claim 19, wherein:
receiving the location information for the location includes receiving the location information as the visual guide is expanded by the user, via the computing device, in the browser; and receiving the size information for the size includes receiving the size information as the visual guide is expanded by the user, via the computing device, in the browser.
